(19) United States
(12) Patent Application Publication
(10) Pub. No.: US 2004/0019813 A1
(43) Pub. Date: Jan. 29, 2004

(54) Recording/playback apparatus and power control method

(75) Inventor: Akihiko Kobayashi, Akishima-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/428,064

(22) Filed: May 2, 2003

(30) Foreign Application Priority Data
Jul. 25, 2002 (JP) 2002-216612

(51) Int. Cl. G06F 1/26

(52) U.S. Cl. 713/300

(57) ABSTRACT

This invention provides a recording/playback apparatus comprising a first unit which performs recording/playback processing of video data, a second unit which communicates with a terminal, and a control section for independently controlling power supplied to the first unit and power supplied to the second unit.

### CROSS-REFERENCE TO RELATED APPLICATIONS

This application is based upon and claims the benefit of priority from the prior Japanese Patent Application No. 2002-216612, filed Jul. 25, 2002, the entire contents of which are incorporated herein by reference.

### BACKGROUND OF THE INVENTION

1. Field of the Invention

The present invention relates to a recording/playback apparatus and, more particularly, to a recording/playback apparatus incorporating a router function.

2. Description of the Related Art

A recording/playback system has been developed, in which a recording/playback apparatus is connected to information processing apparatuses (e.g., a personal computer, PDA, and cell phone) through a network. In this system, while digital media data such as TV picture data or video picture data is recorded in a storage device (e.g., an HDD or optical disk) in the recording/playback apparatus, the multimedia data is transmitted to an information processing apparatus to play back the transmitted multimedia data on the information processing apparatus. Such a recording/playback apparatus incorporates a router for performing routing processing of network data.

In the recording/playback apparatus with the built-in router, power is supplied to both the recording/playback section and the router section.

As described above, in the conventional recording/playback apparatus with the built-in router, since power is supplied to both the recording/playback section which records and plays back video data and the router section which performs routing processing, power is wasted while the recording/playback section is not used.

### BRIEF SUMMARY OF THE INVENTION

According to the first aspect of the present invention, there is provided a recording/playback apparatus comprising a first unit which performs recording/playback processing of video data, a second unit which communicates with a terminal, and a controller independently controlling power supplied to the first unit and power supplied to the second unit.

According to the second aspect of the present invention, there is provided a power control method in a recording/playback apparatus including a first unit which performs recording/playback processing of video data, and a second unit which communicates with a terminal, comprising determining whether a first command indicating use of the first unit is received from the terminal, supplying power to the first unit when determining that the first command is received, determining whether a second command indicating inhibition of use of the first unit is received, and shutting off power supplied to the first unit when determining that the second command is received.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 is a view showing a home network system using a recording/playback apparatus with a built-in router according to an embodiment of the present invention;

FIG. 2 is a block diagram for explaining the arrangement of a wireless AV station 101; and

FIG. 3 is a flow chart for explaining the operation of the recording/playback apparatus with the built-in router according to the embodiment of the present invention.

### DETAILED DESCRIPTION OF THE INVENTION

A recording/playback apparatus with a built-in router according to an embodiment of the present invention will be described below with reference to the several views of the accompanying drawing.

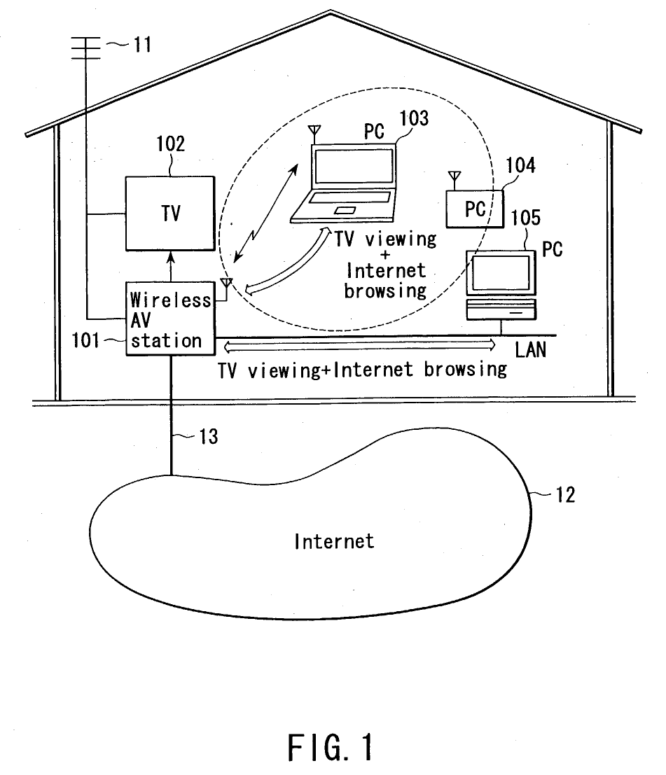

FIG. 1 is a view showing a home network system using a recording/playback apparatus with a built-in router according to an embodiment of the present invention.

This home network system is comprised of a wireless AV (Audio Video) station 101 which is a recording/playback apparatus with a built-in router, a TV receiver 102, various information processing terminals such as notebook type personal computers 103 and 104 and desktop type personal computer 105, and the like. The wireless AV station 101 is a recording/playback apparatus with a built-in router which serves as a home network server. The wireless AV station 101 wirelessly provides various information processing terminals in a home, such as the personal computers 103 to 105, with services associated with viewing of broadcast program data by TV broadcasting, Internet browsing, and the like.

The wireless AV station 101 is connected to an external global network (external network) such as Internet 12 through a communication line 13, e.g., ISDN, ADSL, or CATV. The wireless AV station 101 is connected to various information processing terminals in the home through a wire or wireless network forming a home network. The notebook type personal computes 103 and 104 have wireless communication devices. Each of these notebook type personal computers 103 and 104 is wirelessly connected to the wireless AV station 101. The desktop type personal computer 105 is connected to the wireless AV station 101 through a wire LAN.

The wireless AV station 101 connects each of the personal computers 103 to 105 to the Internet 12 to transmit and receive data between Web sites on the Internet 12 and the respective personal computers 103 to 105.

An antenna cable connected to a TV broadcast reception antenna 11 installed outside the house is introduced into the house. The TV receiver 102 and wireless AV station 101 are connected to this antenna cable. TV broadcast programs can be played back by the TV receiver 102 and received by the wireless AV station 101. The wireless AV station 101 can wirelessly transmit received TV broadcast program data to the notebook type personal computers 103 and 104 through the wireless LAN and also can transmit it to the desktop type personal computer 105 through the wire LAN.

The main functions provided by the wireless AV station 101 are:

Wireless Router Function:

This is a function of connecting each information processing terminal in a communicative state to the Internet 12 through the wireless LAN and transmitting and receiving data between a WEB site on the Internet 12 and each information processing terminal. The use of the notebook type personal computers 103 and 104 connected to the wireless AV station 101 through the wireless LAN allows the user to wirelessly perform Internet browsing in any place in the house.

TV Function:

This is a function of transmitting TV broadcast program data received by the wireless AV station 101 to each information processing terminal connected to the wireless AV station 101 through the wireless LAN or wire LAN. The use of the notebook type personal computers 103 and 104 allows the user to wirelessly view a live TV broadcast program in any place in the house.

TV Recording Function:

A magnetic disk drive unit (hard disk drive (HDD)) is built in the wireless AV station 101. The user can therefore record a TV broadcast program in the magnetic disk drive unit while wirelessly viewing the TV broadcast program. In addition, while transmitting the TV broadcast program data recorded in the magnetic disk drive unit to an information processing terminal, the user can receive another live TV broadcast program data and record it in the magnetic disk drive unit. By outputting the TV broadcast program data recorded in the magnetic disk drive to the TV receiver 102, the user can view it on a large screen.

Remote Control Function:

The TV function, TV recording function, and the like of the wireless AV station 101 can be remotely controlled from the personal computers 103 to 105. In addition, the TV function, TV recording function, and the like of the wireless AV station 101 can be controlled by using a dedicated remote control unit.

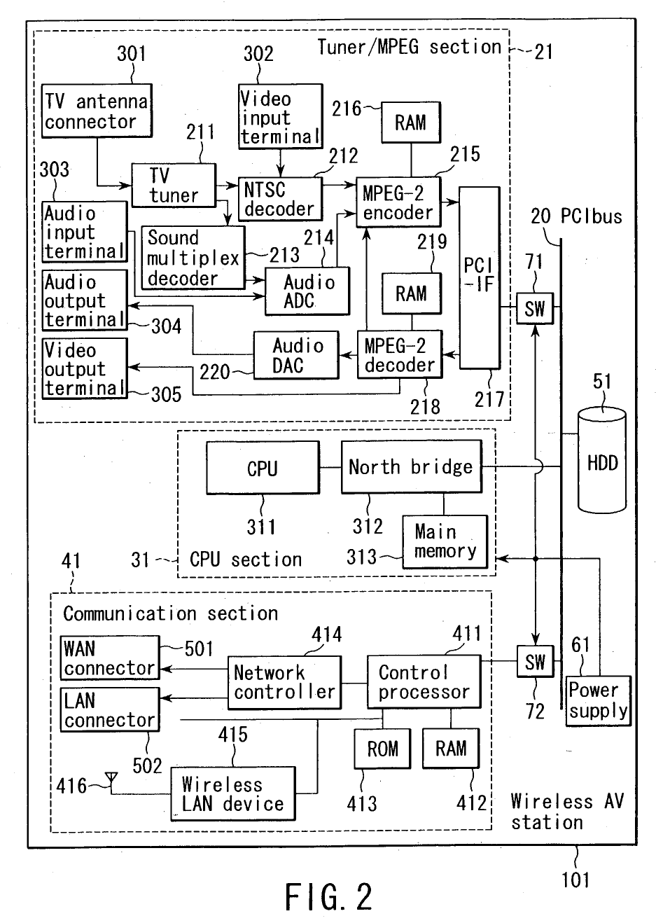

The arrangement of the wireless AV station 101 will be described next with reference to FIG. 2.

As shown in FIG. 2, the wireless AV station 101 roughly includes by three components, namely a tuner/MPEG section 21, CPU section 31, and communication section 41. The tuner/MPEG section 21, CPU section 31, and communication section 41 are connected to a bus 20 such as a PCI bus. A magnetic disk drive unit (hard disk drive (HDD)) 51 is also connected to the bus 20.

The tuner/MPEG section 21 executes reception processing of TV broadcast program data, encoding processing of compression-encoding the received TV broadcast program data, decoding processing of decoding the compression-encoded TV broadcast program data. As shown in FIG. 2, the tuner/MPEG section 21 includes a TV tuner 211, NTSC decoder 212, sound multiplex decoder 213, audio A/D converter (audio ADC) 214, MPEG-2 encoder 215, RAM 216, PCI bus interface (PCI-IF) 217, MPEG-2 decoder 218, RAM 219, audio D/A converter (audio DAC) 220, and the like.

The TV tuner 211 is connected to the TV antenna cable through a TV antenna connector 301. The TV tuner 211 serves to receive TV broadcast program data on a channel to which a view request is issued from one of the personal computers 103 to 105 or the remote controller. The TV tuner 211 receives a TV broadcast signal and select a channel in accordance with a view request. TV broadcast program data on a given channel received by the TV tuner 211 is sent to the NTSC decoder 212 to be separated into a video signal (motion picture) and audio signal, and is converted into digital data as needed.

The NTSC decoder 212 is also connected to a video input terminal 302 and can also input a video signal from an external video device such as a DVD player or VCR. The sound multiplex signal superimposed on TV broadcast program data is demodulated by the sound multiplex decoder 213. The resultant data is sent to the audio A/D converter (audio ADC) 214 to be converted into digital data. The audio A/D converter (audio ADC) 214 is also connected to an audio input terminal 303 and can also input an audio signal from an external video/audio device.

The MPEG-2 encoder 215 compression-encodes input video and audio data. MPEG-2 is used for this compression encoding. The RAM 216 is used as a work memory for allowing the MPEG-2 encoder 215 to perform compression encoding. The TV broadcast program data received by the TV tuner 211 is compression-encoded by the MPEG-2 encoder 215 to be converted into an MPEG-2 stream.

The PCI bus interface (PCI-IF) 217 is an interface for connecting the tuner/MPEG section 21 to the bus 20, and is used to communicate with the CPU section 31 and HDD 51 through the bus 20. A register group which the CPU section 31 can access is built into the PCI bus interface (PCI-IF) 217. The operations of the TV tuner 211 and MPEG-2 encoder 215 are controlled in accordance with the commands set in the register group by the CPU section 31.

The MPEG-2 decoder 218 decodes TV broadcast program data compression-encoded in the MPEG-2 format. When, for example, the user is to view the compression-encoded TV broadcast program data recorded in the HDD 51 through the TV receiver 102, the compression-encoded TV broadcast program data read out from the HDD 51 is sent to the MPEG-2 decoder 218 through the PCI bus interface (PCI-IF) 217 to be decoded (decompressed). The RAM 219 is used as a work memory for allowing the MPEG-2 decoder 218 to perform decoding. The operation of the MPEG-2 decoder 218 is also controlled in accordance with the commands set in the register group in the PCI bus interface (PCI-IF) 217.

The video data decoded by the MPEG-2 decoder 218 is sent to the TV receiver 102 or the like through a video output terminal 305. The audio data decoded by the MPEG-2 decoder 218 is converted into an analog signal by the audio D/A converter (audio DAC) 220 as needed, and is output from an audio output terminal 304 to an external audio/video device.

In addition, in this embodiment, the TV broadcast program data decoded by the MPEG-2 decoder 218 can be transmitted to the MPEG-2 encoder 215 to be compression-encoded again. This processing is used for downconversion processing of converting the transmission rate (bit rate) of the compression-encoded TV broadcast program data recorded in the HDD 51 into a specific transmission rate for wireless transmission.

That is, the TV broadcast program data obtained by compression encoding processing by the MPEG-2 encoder 215 vary in transmission rate (bit rate) depending on the picture quality (low picture quality, standard picture quality, and high picture quality) of TV broadcast program data to be recorded in the HDD 51. When high picture quality is selected, TV broadcast program data that is compression-encoded at a very high transmission rate is recorded in the HDD 51. In this case, obviously, the TV broadcast program data may not be transmitted in real time depending on the wireless communication band. In such a case, downconversion processing is automatically executed to decrease the transmission rate of the TV broadcast program data to be wirelessly transmitted into a specific transmission rate for wireless communication.

The CPU section 31 controls the TV tuner 211, MPEG-2 encoder 215, and MPEG-2 decoder 218 of the tuner/MPEG section 21, and also controls data write operation to the HDD 51 and data read operation from the HDD 51. The CPU section 31 also receives commands associated with TV viewing which are sent from the personal computers 103 to 105 by communicating with the communication section 41, and transmits TV broadcast program data to the communication section 41, which are to be transmitted to the personal computers 103 to 105. The CPU section 31 is comprised of a CPU 311, a north bridge 312 which connects the CPU bus of the CPU 311 to the PCI bus 20, and a main memory 313.

The communication section 41 is a communication controller capable of independently operating as a wireless LAN router. The communication section 41 is designed to be wirelessly connected to the personal computers 103 and 104 and to be connected to the personal computer 105 through the wire LAN. The communication section 41 connects the personal computers 103 to 105 to the Internet 12 to transmit and receive data between the personal computers 103 to 105 and the Internet 12 in accordance with the requests transmitted from the personal computers 103 to 105. In this case, all the processing associated with transmission/reception of data between the personal computers 103 to 105 and the Internet 12 is performed inside the communication section 41 without using the CPU section 31.

As shown in FIG. 2, the communication section 41 includes a control processor 411, RAM 412, ROM 413, network controller 414, wireless LAN device 415, WAN connector 501, LAN connector 502, and the like.

The WAN connector 501 is a broadband terminal used for transmission/reception of data to/from the Internet 12, and is connected to, for example, the communication line 13 through a modem or the like. The LAN connector 502 is connected to the home wire LAN.

The network controller 414 is a network control device which controls transmission/reception of data to/from the Internet 12 through the WAN connector 501, and transmission/reception of data to/from the home wire LAN through the LAN connector 502. The wireless LAN device 415 is a wireless communication device which performs transmission/reception of data to/from the personal computers 103 and 104 through the wireless LAN, and wirelessly communicates with the personal computers 103 and 104 through an antenna 416. As the wireless LAN device 415, a device complying with a standard such as IEEE802.11b or IEEE802.11a is used.

The control processor 411 controls the network controller 414 and wireless LAN device 415 to control transmission/reception of data between each of the personal computers 103 to 105 and the Internet 12. More specifically, the control processor 411 includes an IP masquerade function, NAT function, DHCP function, and the like as functions required for the communication section 41 to operate as a wireless router. The control processor 411 is also connected to the PCI bus 20 and has a function of notifying the CPU 311, through the PCI bus 20, of requests (commands) associated with TV viewing which are received from the personal computers 103 and 104 through the wireless LAN device 415, and notifying the CPU 311, through the PCI bus 20, of requests (commands) associated with TV viewing which are received from the personal computer 105 on the wire LAN through the network controller 414.

The control processor 411 also has the following function. Upon reception of TV broadcast program data transferred from the CPU 311 through the PCI bus 20, the control processor 411 transmits the TV broadcast program data to a request source personal computer through the wireless LAN device 415 or network controller 414. In this case, transmission processing of the TV broadcast program data to the request source personal computer is done concurrently with transmission/reception of data between the personal computer and the Internet 12.

Assume that the personal computer 103 that can wirelessly connect to the communication section 41 is wirelessly performing Internet browsing. In this case, when the TV program data requested by the personal computer 103 is to be wirelessly transmitted to the personal computer 103, the control processor 411 controls the wireless LAN device 415 to time-divisionally transmit the content data received from a WEB server on the Internet 12 and the TV broadcast program data compression-encoded by the tuner/MPEG section 21 to the personal computer 103 by wireless communication. More specifically, the control processor 411 multiplexes the content data with the compression-encoded TV broadcast program data. The multiplexed content data and TV broadcast program data are time-divisionally transmitted to the personal computer 103 by wireless communication. Sending the content data and TV broadcast program data as independent data to the personal computer 103 in this manner allows the personal computer 103 to simultaneously display the content data and TV broadcast program data by using corresponding application programs. In addition, this makes it possible to freely change the display positions and display sizes of the content data and TV broadcast program data in the respective windows by using corresponding application programs.

The function of the control processor 411 described above is realized by the firmware stored in the ROM 413.

Power from a power supply 61 is supplied to the CPU section 31, to the tuner/MPEG section 21 through a switch 71, and to the communication section 41 through a switch 72. The CPU 311 of the CPU section 31 independently controls the switches 71 and 72 to ON/OFF-control power to be supplied to the tuner/MPEG section 21 and communication section 41.

The operation of recording/playback apparatus with the built-in router according to the embodiment of the present invention will be described next.

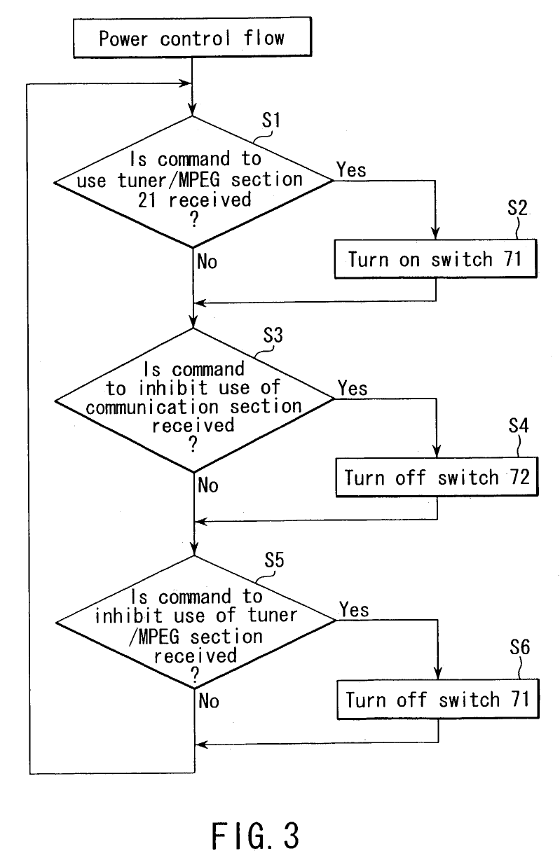

FIG. 3 is a flow chart for explaining the operation of the recording/playback apparatus with the built-in router according to the embodiment of the present invention.

Assume that in this embodiment, the switch 72 is ON so that power from the power supply 61 is supplied to the CPU section 31 and to the communication section 41 through the switch 72, and communication and routing processing with another terminal can be done. Note that the switch 72 can be turned off by the CPU 311.

First of all, it is checked whether a command indicating the use of the tuner/MPEG section 21 is received from an external terminal through the communication section 41 (S1). If it is determined in step S1 that a command indicating the use of the tuner/MPEG section 21 is received, the switch 71 is turned on under the control of the CPU 311 to supply power to the tuner/MPEG section 21 to set the tuner/MPEG section 21 in a ready state. With this operation, processing corresponding to the command such as a command to play back video data is executed by the tuner/MPEG section 21.

If it is determined in step S1 that no command indicating the use of the tuner/MPEG section 21 is received, or the switch 71 is turned on in step S2, it is checked whether a command to inhibit the use of the communication section 41 is received (S3).

If it is determined in step S3 that a command to inhibit the use of the communication section 41 is received, the switch 72 is turned off. With this operation, no power is supplied from the power supply 61 to the communication section 41.

If it is determined in step S3 that no command to inhibit the use of the communication section 41 is received, and the switch 72 is turned on in step S4, it is checked whether a command to inhibit the use of the tuner/MPEG section 21 is received (S5).

If it is determined in step S5 that a command to inhibit the use of the tuner/MPEG section 21 is received, the switch 71 is turned off to turn off the power supply 61 for the tuner/MPEG section 21. With this operation, when neither video playback nor video recording is to be done, power saving can be realized by turning off only the power supply for the tuner/MPEG section 21.

If it is determined in step S5 that no command to inhibit the use of the tuner/MPEG section 21 is received, or the switch 71 is turned off in step S6, the flow returns to the processing in step S1.

In the recording/playback apparatus with the built-in router according to the embodiment of the present invention, therefore, since power supplied to the tuner/MPEG section 21 and power supplied to communication section 41 can be independently controlled, when no video recording/playback is to be done, power saving can be realized by turning off the power supply for the tuner/MPEG section 21. In addition, since power supplied to the communication section 41 is ensured, communication between the recording/playback apparatus with the built-in router and another terminal can be maintained. This allows external control on the power supply.

The above embodiment has exemplified the case wherein the power is turned on and off. However, power saving can also be realized by independently controlling clocks supplied to the tuner/MPEG section 21 and communication section 41. For example, only clock signals supplied to the communication section 41 and CPU section 31 are normally enabled, whereas clocks signals supplied to the tuner/MPEG section 21 are enabled only when video recording/playback is to be done, and disabled when no video recording/playback is to be done, thereby realizing power saving.

The present invention is not limited to the embodiment described above, and can be variously modified in the execution phase without departing from the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording/playback apparatus comprising:
a first unit which performs recording/playback processing of video data;
a second unit which communicates with a terminal; and
a controller independently controlling power supplied to the first unit and power supplied to the second unit.

2. An apparatus according to claim 1, wherein the controller supplies power to only the second unit when the first unit is not used.

3. An apparatus according to claim 1, wherein the controller supplies power to the first unit upon reception of a command indicating use of the first unit from the terminal, and shuts off power supplied to the first unit upon reception of a command indicating inhibition of use of the first unit.

4. A power control method in a recording/playback apparatus including a first unit which performs recording/playback processing of video data, and a second unit which communicates with a terminal, comprising:
determining whether a first command indicating use of the first unit is received from the terminal;
supplying power to the first unit when determining that the first command is received;
determining whether a second command indicating inhibition of use of the first unit is received; and
shutting off power supplied to the first unit when determining that the second command is received.

5. A method according to claim 4, further comprising steps of:
determining whether a third command indicating inhibition of use of the second unit is received, and
shutting off power supplied to the second unit when determining that the third command is received.
